(19) United States
(12) Patent Application Publication
(10) Pub. No.: US 2021/0248695 A1
(43) Pub. Date: Aug. 12, 2021

(54) COORDINATED DELIVERY OF DINING EXPERIENCES

(71) Applicant: Martin Garcia-Brosa, Cutler Bay, FL (US)

(72) Inventor: Martin Garcia-Brosa, Cutler Bay, FL (US)

(21) Appl. No.: 17/173,848

(22) Filed: Feb. 11, 2021

Related U.S. Application Data
(60) Provisional application No. 62/972,762, filed on Feb. 11, 2020.

(51) Int. Cl. G06Q 50/12; G06Q 30/06; G06Q 10/10; G06Q 10/08

(52) U.S. Cl. CPC G06Q 50/12; G06Q 30/0605; G06Q 20/12; G06Q 10/087; G06Q 10/1097

(57) ABSTRACT

According to one aspect of the present disclosure, a driver management platform may be configured to do the following: receive a multi-restaurant request, the multi-restaurant request comprising a request of one or more food items associated with a plurality of restaurants from at least one customer; analyze, via the multi-restaurant request, the following: location data of the restaurants, food parameters, prioritize, based on the analysis, the following: pickup times of the one or more food items, and delivery times to the at least one customer; request at least one delivery provider, the request comprising: an availability to arrive at the plurality of pickup times and the plurality of delivery times, and at least one prerequisite item relating to the multi-restaurant request; and schedule, upon an acceptance of the at least one delivery provider, with the at least one delivery provider, the pickup times and delivery times.

### RELATED APPLICATION

The present application claims the benefit under the provisions of 35 U.S.C. § 119(e) to U.S. Provisional Application No. 62/972,762 filed Feb. 11, 2020, which is hereby incorporated by reference herein in its entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure relates to devices, systems, and methods for coordinating the delivery of a dining experience to customers, for example, through a food delivery service.

### BACKGROUND OF THE DISCLOSURE

Generally, customers desiring particular food items must determine particular restaurants that can prepare such food items, order said food items, and either pick up the food items or have them delivered. In some scenarios, a particular restaurant may only offer a portion of the desired food items, for example, an appetizer, while a second restaurant may offer a different portion, for example, an entrée. In these scenarios, the customer must pick up each food item individually, or have them delivered from multiple food delivery providers. It follows, that these food items may be at an unideal temperature when delivered or picked up due to the multiple stops involved in completing acquisition from multiple restaurants or arrive at different moments.

Accordingly, there remains a need for coordinated preparation and delivery of dining experiences that overcome these and other drawbacks. These and other needs are satisfied by the various aspects of the present disclosure.

### BRIEF OVERVIEW OF THE DISCLOSURE

In accordance with the purposes of the disclosure, as embodied and broadly described herein, the disclosure, in one aspect, relates to coordinating the delivery of a dining experience to customers, for example, through a food delivery service.

According to one aspect, a software-based operation and management platform is provided to manage certain preparation, pickup, and delivery orders. The platform may be used by multiple restaurants, regardless of their facility location. Moreover, the platform may also be used by common kitchen facilities, as will be further detailed below.

The software can control various aspects related to the food preparation, timing, and scheduling of pickups and delivery. The software can also manage the same activities in regard to preparation, timing, scheduling of pickups of food providers outside of the building, in combination with restaurants in a common kitchen facility. The software can allow a customer to define a delivery time for a multi-restaurant order, and schedule the activities of the restaurants participating in the order, considering preparation and delivery/traffic time in the planning.

According to additional aspects, the scheduling will consider the preparation time of each recipe, and may include a database with the preparation time per recipe per restaurant.

According to additional aspects, the scheduling will consider the delivery and pickup delay/time of each recipe, and may include a database with the delivery times and/or pickup times per restaurant.

According to additional aspects, the scheduling will consider traffic delays, temperature increase/decrease based on travel time, weather, and other potential delays and impacts in delivering a desirable dining experience.

According to additional aspects, digital marketing services and monetization services may be provided to platform users to facilitate growth of their business and geographical presence.

According to one aspect, a building (e.g., a warehouse-like facility) with many commercially operable kitchens may be provided. A “tenant” of such a facility would be a food provider such as, for example, a restaurant or a virtual restaurant that desires to have a kitchen in the building. As used herein, virtual restaurants can be defined as restaurants with a brand that only sell through delivery, or do not have a physical establishment for customers to dine within.

It is noted that expanding to additional locations and, thus, additional geographic territories, enables the expansion of the restaurant's prospective customer base. By renting a kitchen in a facility consistent with aspects of the present disclosure, a restaurant can expand its territory without committing additional resources beyond the kitchen and cook/s, thereby saving on dine-in resources such as staff, tables, supplies, service, and other patron servicing requirements. This facilitates the restaurant to gain market share on purely delivery and carry-out customers, leading to higher margins on their products. By the transient nature of a kitchen rental, the restaurant may obtain the data it needs to decide if the new location warrants an expansion of its dine-in segment.

It is further anticipated that aspects of the disclosure will benefit consumers as well as restaurants. For instance, a consumer may desire an ‘appetizer’ from a first restaurant, but an ‘entree’ from a second restaurant. There is no current solution that would enable the consumer to receive both items, from different restaurants, at the same time, using the same delivery service, within a reasonable time such that the food, when received, remains at a reasonable temperature for consumption. Additionally, the consumer could schedule the delivery time of its multi-restaurant order, and aspects disclosed herein will organize the preparation of the food at the restaurants providing the order, considering preparation and delivery times, including traffic.

Moreover, there is no current solution that enables a restaurant to synchronously time the preparation of their food in conjunction with a multi-stop route by a decentralized driver. Thus, management software aspects of the present disclosure may be comprised of components including: 1) consumer-facing, multi-restaurant piecemeal delivery; and, 2) management of decentralized food preparation from multiple restaurants as applied to the same order. It should be noted that, in certain embodiments, the multi-point delivery may all be from the same warehouse comprising different kitchens.

Moreover, by enabling such piecemeal delivered from a plurality of food providers, this not only benefits the customer, but the food provider may stand to increase sales. The restaurant can increase sales—and not just by geographic expansion alone, but by enabling customers to only order their favorite items from their favorite restaurant, whereas before they would face an ‘all or nothing’ decision.

Generally, according to aspects of the disclosure, a method of delivery of a dining experience can include presenting a menu or multiple menus from different restaurants to a customer, receiving a request from the customer including at least one food item, and coordinating completed order pickup from one or more restaurants by a delivery provider such that a consistent and pleasing dining experience is provided to the customer.

The method of delivery of the dining experience can also include associating traffic data, weather data, ranking data, and/or other applicable data to match delivery providers with restaurants such that the consistent and pleasing dining experience is facilitated. Delivery providers may be affiliated with the food provider (e.g., the restaurant) by way of, for example, but not limited to, employment, contracting, or third-party selection through the platform of the present disclosure.

In still further aspects, the disclosure also relates to devices and systems utilizing or facilitating the methods described herein.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate several aspects of the disclosure and together with the description, serve to explain the principles of the disclosure.

FIG. 1 is an overview of a system or platform 100, according to an exemplary embodiment of the present disclosure.

FIG. 2 is a flowchart of a method 200, according to an exemplary embodiment of the present disclosure.

FIG. 3 is a flowchart of a method 300, according to an exemplary embodiment of the present disclosure.

FIG. 4 is a flowchart of a method 400, according to an exemplary embodiment of the present disclosure.

FIG. 5 is a flowchart of a method 500, according to an exemplary embodiment of the present disclosure.

FIG. 6 illustrates a computing device, according to an exemplary embodiment of the present disclosure.

### DETAILED DESCRIPTION OF THE DISCLOSURE

The present disclosure can be understood more readily by reference to the following detailed description of the disclosure and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Any and all publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an assembly” includes two or more assemblies.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Disclosed are the components to be used to manufacture the disclosed devices and articles of the disclosure as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the disclosure. Thus, if there are a variety of additional steps that can be performed it is understood that each of these additional steps can be performed with any specific aspect or combination of aspects of the methods of the disclosure.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### Platform Architecture

As briefly described above, the present disclosure relates, in various aspects, to methods, devices, and systems for coordinated delivery of dining experiences to customers. Turning now to the figures, several aspects of the present disclosure are described in detail. It is noted that the drawings are not to scale, and are not exhaustive of all aspects of the present disclosure.

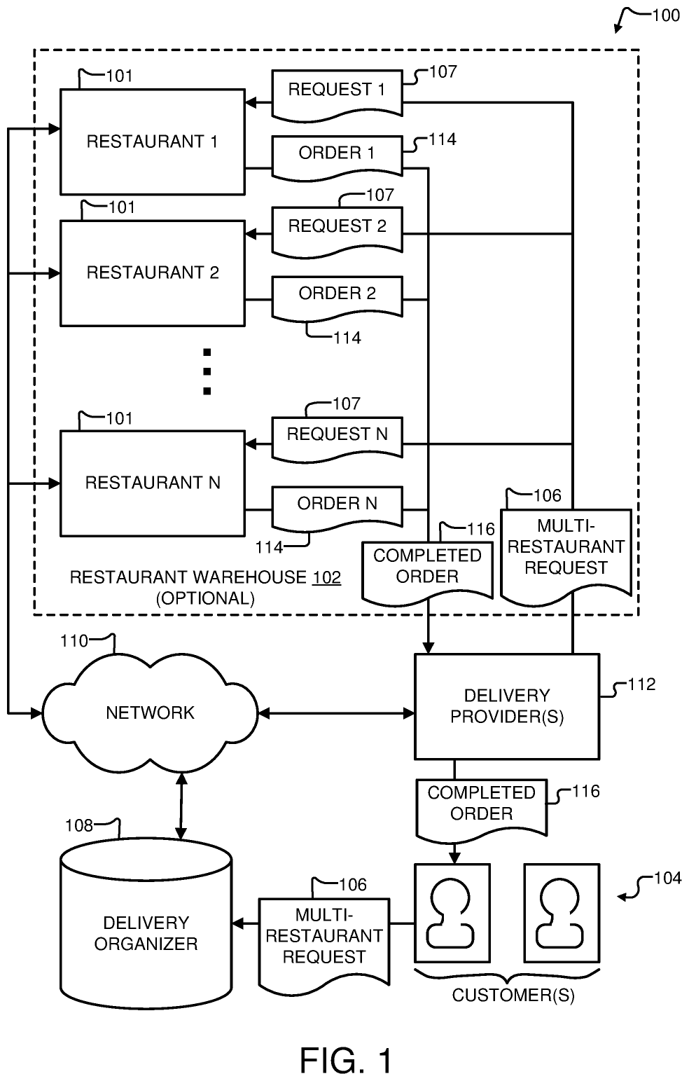

FIG. 1 is an overview of a system or platform 100, according to an embodiment of the present disclosure. As illustrated, platform 100 includes an optional warehouse facility 102 where a plurality of restaurants 101 may be organized and situated for operation and preparation for food and recipes. As noted, the warehouse configuration 102 may be optional, or may be in combination with external restaurant facilities. Accordingly, the restaurants 101 may be external to a warehouse, internal to warehouse, or in combination internal and external to a warehouse.

By way of non-limiting example, platform 100 may be hosted on, for example, a cloud computing service. In some embodiments, the platform 100 may be hosted on a computing device 600. A user may access platform 100 through a software application and/or hardware device. The software application may be embodied as, for example, but not be limited to, a website, a web application, a desktop application, and a mobile application compatible with the computing device 600.

Still consistent with embodiments of the present disclosure, platform 100 may be, for example, but not limited to, a software development kit (SDK)/application programming interface (API). The SDK/API may be used by third parties to integrate some or all of the functions disclosed herein. Furthermore, the SDK/API may allow for the customization of some or all of the functions disclosed herein, to meet the needs of third parties implementing platform 100.

In yet further embodiments of the present disclosure, platform 100 may implement an SDK/API to integrate with third-party solutions. For example, and as mentioned below, platform 100 may integrate with a delivery provider's management platform to manage the delivery aspects disclosed herein. In yet another example, platform 100 may integrate with an inventory management platform used by, for example, restaurants. It should be understood that the SDK/API integrations may enable administers to selectively use and deploy various functions and features herein, in any customized integration with existing third-party platforms.

The platform 100 may include a network 110 to facilitate communication between the restaurants 101, between the restaurants 101 and a delivery provider 112, between the restaurants 101 and customers 104, and/or between the delivery provider 112 and customers 104.

In accordance with various embodiments disclosed herein, delivery provider 112 may be affiliated with the food provider (e.g., the restaurant 101) by way of, for example, but not limited to, employment, contracting, or third-party selection through platform 100 of the present disclosure. The selection may be provided by, either one of the restaurants 101 or the customer 104. Furthermore, these sections may be facilitated through platform 100. Further still, in some embodiments, the delivery provider 112 may comprise a delivery management platform that is in bi-directional communication with platform 100. In turn, the delivery management platform and platform 100 may share data, computer-instructions, and any other aspect to inform, commission, manage, or otherwise track the delivery status of order received by platform on customer 104.

Generally, the customers 104 may place a multi-restaurant request 106 comprising one or more food items or recipes associated with the restaurants 101. The multi-restaurant request 106 may also be a single restaurant request in some embodiments.

The multi-restaurant request 106 may be received and processed by a delivery organizer 108. The delivery organizer 108 may be a software component or a plurality of software components configured to execute computer-readable instructions associated with one or more of methods 200, 300, 400, and/or 500, which are described in more detail herein. In some embodiments, delivery organizer 108 may be configured to identify a time latency to begin a new food item preparation for each of the plurality of restaurants. In further embodiments, delivery organizer 108 may be configured to compare a plurality of predetermined preparation times of the one or more food items associated with the plurality of restaurants.

The delivery organizer 108 may be configured to process the multi-restaurant request 106 such that particular food items are ordered from particular restaurants 101, such that payment to the restaurants are effectively distributed, such that delivery provider 112 is effectively coordinated to facilitate delivery to customers 104, and such that payment to the delivery provider is effectively distributed. The delivery organizer 108 may use a web application, mobile application, or other interface to receive payment and requests from the customers 104.

Upon processing of the multi-restaurant request 106, the delivery organizer may distribute a series of processed requests 107 to each associated restaurant 101. Furthermore, the delivery organizer 108 may distribute the multi-restaurant request to the delivery provider 112. The processed requests 107 may include data relating to preparation times for each food item in the request 107, as well as recommended food preparation start times, estimated pickup times of the delivery provider 112, and other related data. Thus, it is anticipated to be within the scope of the present disclosure that platform 100 may provide instructions to, by way of non-limiting example, kitchen personnel.

In various embodiments, preparation times may be a data point available for each food item in the request 107. The data points may be provided by, for example, restaurant 101. For instance, during an on-boarding aspect of the restaurant's adoption of platform 100, or at any other point in time, preparation times for each food item may be received by platform 100. While, in other embodiments, the datapoints may be ascertained from various other databases.

It is noted, that according to some embodiments, the processed requests 107 may be provided to the restaurants 101 by the delivery provider 112. According to other embodiments, a portion of the processed requests 107 may be provided by the delivery organizer 108, while an additional portion may be provided by the delivery provider 112.

Responsive to receiving a request 107, the restaurants 101 may begin preparation of each associated food item or recipe such that the anticipated pickup times are met. According to some embodiments, the anticipated pickup times may be based on a window or sliding scale of time based on external factors, such as traffic, weather, and aspects of the recipe, including cooldown time (for hot recipes), heat up time (for cold or room temperature recipes such as salads, desserts, etc.), desired temperature at delivery, and other aspects. Furthermore, in some embodiments, a delivery driver profile may be provided. Said profile may include data, such as, but not limited to, various aspects of the delivery (e.g., thermal containers, chaffing tools, or coolers), that would factor into the delivery time calculation for ensuring timely delivery of a particular recipe.

Each food item prepared may be organized by the restaurants 101 include individual order portions 114. The individual order portions 114 may be collected by the delivery provider 112 and assembled into completed order 116. The completed order 116 may be stowed by the delivery provider for delivery to the customers 104.

According to some embodiments, the delivery provider 112 may stow all or a portion of the completed order 116 into specialized temperature control apparatuses for maintaining a desirable temperature. Upon delivery, the completed order 116 may be at a desirable temperature thereby ensuring a pleasing dining experience to the customers 104 as compared to conventional delivery services.

It is noted that the coordination of the delivery and payment to the restaurants 101 and delivery provider 112 may vary in many ways. Hereinafter, particular details related to methods of coordinating delivery of a dining experience are presented in detail.

### Platform Operation

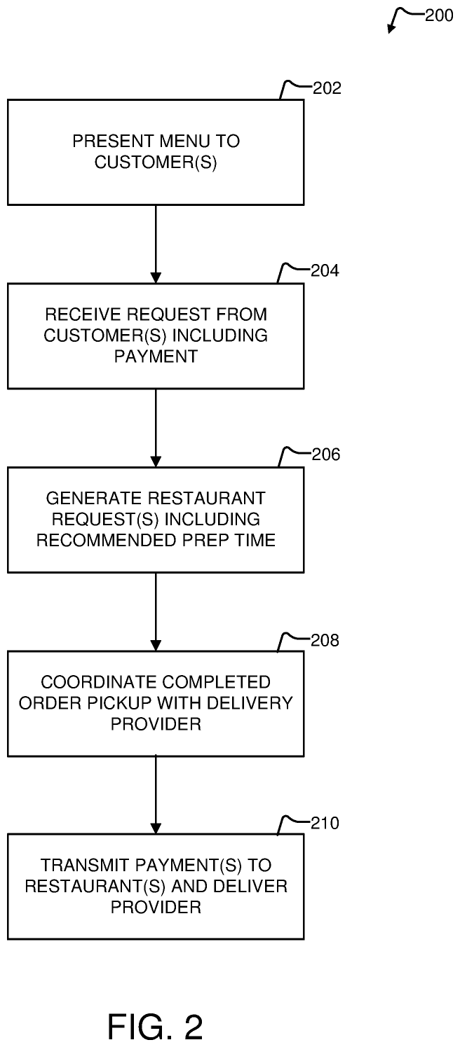

Hereinafter, detailed discussion of the operation of the platform 100 is provided with reference to FIGS. 2-5 and associated methods of coordinating delivery of a dining experience to customers.

FIG. 2 is a flowchart of a method 200, according to an exemplary embodiment of the present disclosure. The method 200 may include presenting a menu or multiple menus from different restaurants to customers, at block 202. The menu may be an aggregated menu of all restaurants 101 to which delivery to the customer is available. The menu may include processing and delivery times, prices, and other data related to a desired dining experience.

The customers may then assemble a request for the desired food items or recipes based on the menu. In response thereto, the method 200 includes receiving the request from the customer, including payment for the food items, at block 204. The request may include all necessary data including delivery address, payment information, contact information, desired delivery time, desired extras or service options, and other relevant data. The request may be for immediately available delivery, delayed delivery, delivery at a particular date, delivery at a particular address, requests for catering services, request for personnel to serve food (e.g., as a catering service), and/or any other options presented through the provided menu.

Upon receipt of the request, the method 200 includes generating processed requests 107 including recommended preparation times, desired pickup times, delivery times, identification of a delivery provider 112, and other processed data, at block 206. The restaurants 101 may user the desired pickup times and/or recommended preparation times to begin preparing one or more portions of the individual requests.

The method 200 may also include coordinating completed order pickup with the delivery provider 112, at block 208. The coordinating may include providing pickup addresses for the restaurants 101, pickup times, traffic data, weather data, and any other data related to facilitating pickup of individual portions 114 to generate a completed order 116. The coordinating may further include scheduling data and requests to ensure the delivery provider 112 picks up portions 114 at particular times to effectively deliver a desirable dining experience to the customer 104.

Upon successful pickup of orders 114, payment may be transmitted to restaurants 101, at block 210. Furthermore, upon successful delivery of the completed order 116 and dining experience to customer 104, payment may be transmitted to the delivery provider 112. It is noted that according to some embodiments, payment(s) may be transmitted at any time, including in batches for multiple orders, depending upon any desired implementation of the embodiments described herein.

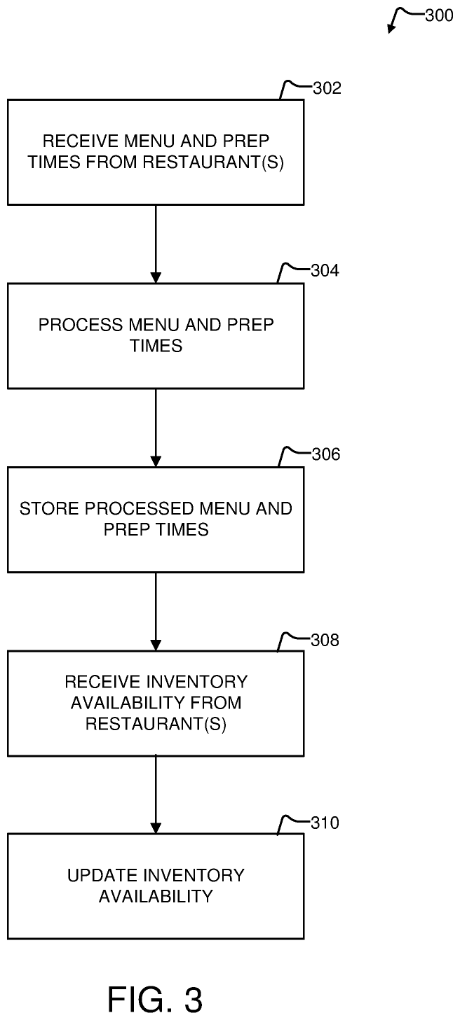

FIG. 3 is a flowchart of a method 300, according to an embodiment of the present disclosure. The method 300 relates to creation of the menu provided to customers at block 202.

The method 300 may include receiving a menu with associated food item/recipe preparation times from restaurants 101, at block 302. The food preparation times may be provided by restaurants 101, and may include considerations such as seasonal variations or other considerations.

The menu and preparation times may be processed at block 304, and stored at block 306. Storage may include storage in a database, storage system, storage apparatus, or other storage types by the delivery organizer 108.

Thereafter, or at substantially the same time, the delivery organizer 108 may receive inventory availability from the restaurants 101, at block 308. The inventory availability may be received on a scheduled basis, may be received on-the-fly, may be received in real-time or in substantially real-time, and may be used to determine availability of particular food items and recipes related to the stored menu items associated with each restaurant 101.

The inventory availability may be updated at block 310, such that customers are presented with up-to-date availability of food items such that incorrect orders are reduced. The inventory availability may also include food preparation hours, operational hours, and other scheduling data.

Using the method 300, the delivery organizer 108 may ensure that customers 104 are effectively provided up-to-date data related to food item availability and scheduling, to facilitate a pleasing dining experience.

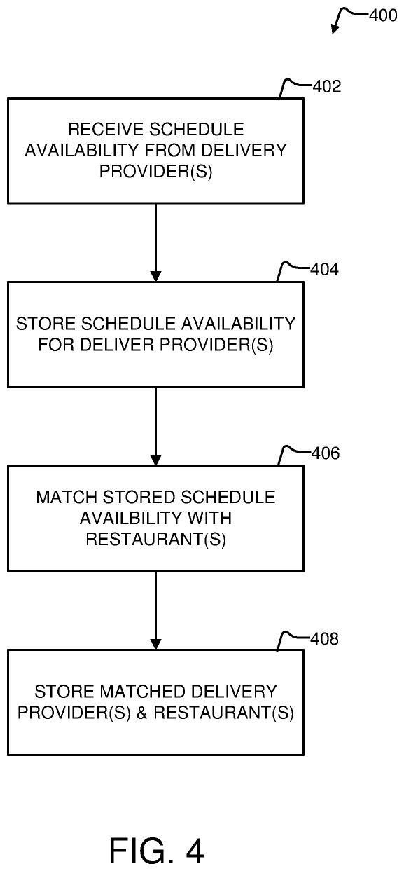

FIG. 4 is a flowchart of a method 400, according to an embodiment of the present disclosure. The method 400 relates to maintaining up-to-date data as to availability of delivery providers 112.

The method 400 includes receiving schedule availability from delivery providers 112, at block 402. The schedule availability may include operational hours, particular delivery service member availability, geographical service data, vehicle types, vehicle equipment (heaters, coolers, refrigeration, etc.), vehicle storage capacity, estimated travel speed/times, and other data related to the delivery providers 112.

The schedule availability and associated data may be stored by the delivery organizer 108, at block 404. The storage may be substantially similar to the storage user for restaurants data described above. Additionally, the schedule availability and associated data may be updated on-the-fly, in real-time or substantially real-time, and/or on an ongoing basis. Accordingly, new service members or off-duty service members of the delivery providers 112 may be quickly accounted for.

The method 400 further includes matching the stored schedule availability and associated data with the restaurants 101, at block 406. The matching may include determining geographical overlap, travel times, scheduling overlap, and other considerations. The matching may also include determining if particular delivery providers 112 have correct equipment for transporting completed orders 116 effectively, to ensure a consistently pleasing dining experience for customers 104.

Rating systems and rankings may be provided for delivery providers 112, according to some embodiments. The rankings may also be used in the matching of block 406 to promote better delivery services for higher-quality dining experiences. The matching data may be stored at block 408 for relatively quick processing of desirable delivery providers 112 to restaurants 101 when receiving customer orders.

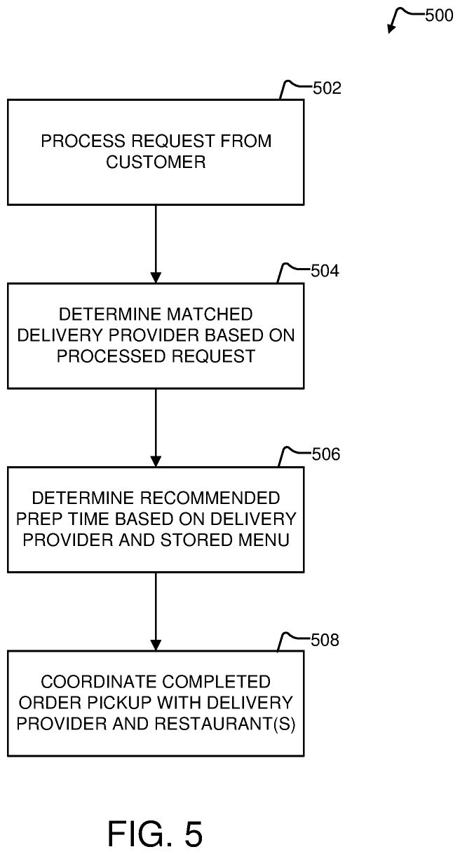

FIG. 5 is a flowchart of a method 500, according to an exemplary embodiment of the present disclosure. The method 500 relates to blocks 206 and 208 of method 200, and coordinating delivery of a dining experience to a customer 104.

The method 500 includes processing a customer order request 106, at block 502. The processing may include determining particular food items associated with particular restaurants 101. The processing may also include determining desired delivery time, estimated preparation and delivery times, estimated traffic delays, estimated weather delays, and other considerations.

Upon processing, the method 500 includes determining a matched delivery provider 112 based on the processing, at block 504. The matched or matching delivery provider 112 may be determined based on stored historical matches (see FIG. 4), based on updated schedule availability, based on ranking, based on vehicle equipment, and other considerations.

After determining an appropriate match or matches, the method 500 includes determining recommended preparation times based on the delivery provider and the stored menu data, at block 506. The recommended preparation times may take all available data, or a portion of available data, into consideration. For example, travel times, traffic delays, weather delays, storage and transport equipment, and other considerations may be applicable to determining when a particular food item should begin to be prepared at a restaurant 101.

Upon establishing and transmitting food preparation data including preparation times, delivery windows, estimated pickup times, and other data, to restaurants 101, the method 500 may include coordinating completed order pickup with the delivery provider 112 and restaurants 101, at block 508. The coordination may include transmitting associated data to both the delivery provider 112 and restaurants 101 such that the restaurants and delivery providers have the same data and can effectively deliver a consistent and pleasing dining experience to the customers 104.

### Computing Device Architecture

At least a portion of the system 100 and associated components may include aspects embodied as, for example, but not be limited to, a website, a web application, a desktop application, backend application, and a mobile application compatible with a computing device 600. The computing device 600 may comprise, but not be limited to the following:

Mobile computing devices, such as, but not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

System 100 may be hosted on a centralized server or a cloud computing service. Although method 200, and methods 300, 400, and 500, have been described to be performed by a computing device 600, it should be understood that, in some embodiments, different operations may be performed by a plurality of the computing devices 600 in operative communication at least one network.

Embodiments of the present disclosure may comprise a system having a central processing unit (CPU) 620, a bus 630, a memory unit 640, a power supply unit (PSU) 650, and one or more Input/Output (I/O) units. The CPU 620 coupled to the memory unit 640 and the plurality of I/O units 660 via the bus 630, all of which are powered by the PSU 650. It should be understood that, in some embodiments, each disclosed unit may actually be a plurality of such units for the purposes of redundancy, high availability, and/or performance. The combination of the presently disclosed units is configured to perform the stages any method disclosed herein.

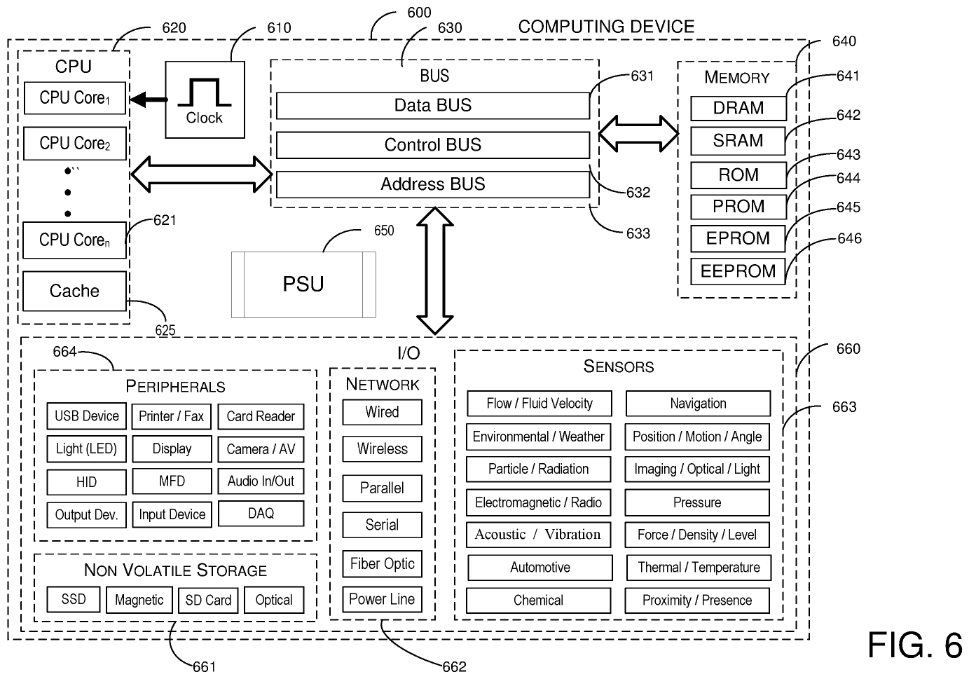

FIG. 6 is a block diagram of a system including computing device 600. Consistent with an embodiment of the disclosure, the aforementioned CPU 620, the bus 630, the memory unit 640, a PSU 650, and the plurality of I/O units 660 may be implemented in a computing device, such as computing device 600 of FIG. 6. Any suitable combination of hardware, software, or firmware may be used to implement the aforementioned units. For example, the CPU 620, the bus 630, and the memory unit 640 may be implemented with computing device 600 or any of other computing devices 600, in combination with computing device 600. The aforementioned system, device, and components are examples and other systems, devices, and components may comprise the aforementioned CPU 620, the bus 630, the memory unit 640, consistent with embodiments of the disclosure.

At least one computing device 600 may be embodied as any of the computing elements illustrated in all of the attached figures. A computing device 600 does not need to be electronic, nor even have a CPU 620, nor bus 630, nor memory unit 640. The definition of the computing device 600 to a person having ordinary skill in the art is “A device that computes, especially a programmable electronic machine that performs high-speed mathematical or logical operations or that assembles, stores, correlates, or otherwise processes information.” Any device which processes information qualifies as a computing device 600, especially if the processing is purposeful.

With reference to FIG. 6, a system consistent with an embodiment of the disclosure may include a computing device, such as computing device 600. In a basic configuration, computing device 600 may include at least one clock module 610, at least one CPU 620, at least one bus 630, and at least one memory unit 640, at least one PSU 650, and at least one I/O 660 module, wherein I/O module may be comprised of, but not limited to a non-volatile storage sub-module 661, a communication sub-module 662, a sensors sub-module 663, and a peripherals sub-module 664.

A system consistent with an embodiment of the disclosure the computing device 600 may include the clock module 610 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 620, the central component of modern computers, which relies on a clock. The only exceptions are asynchronous circuits such as asynchronous CPUs. The clock 610 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 600 use a “clock multiplier” which multiplies a lower frequency external clock to the appropriate clock rate of the CPU 620. This allows the CPU 620 to operate at a much higher frequency than the rest of the computer, which affords performance gains in situations where the CPU 620 does not need to wait on an external factor (like memory 640 or input/output 660). Some embodiments of the clock 610 may include dynamic frequency change, where, the time between clock edges can vary widely from one edge to the next and back again.

A system consistent with an embodiment of the disclosure the computing device 600 may include the CPU unit 620 comprising at least one CPU Core 621. A plurality of CPU cores 621 may comprise identical the CPU cores 621, such as, but not limited to, homogeneous multi-core systems. It is also possible for the plurality of CPU cores 621 to comprise different the CPU cores 621, such as, but not limited to, heterogeneous multi-core systems, big.LITTLE systems and some AMD accelerated processing units (APU). The CPU unit 620 reads and executes program instructions which may be used across many application domains, for example, but not limited to, general purpose computing, embedded computing, network computing, digital signal processing (DSP), and graphics processing (GPU). The CPU unit 620 may run multiple instructions on separate CPU cores 621 at the same time. The CPU unit 620 may be integrated into at least one of a single integrated circuit die and multiple dies in a single chip package. The single integrated circuit die and multiple dies in a single chip package may contain a plurality of other aspects of the computing device 600, for example, but not limited to, the clock 610, the CPU 620, the bus 630, the memory 640, and I/O 660.

The CPU unit 620 may contain cache 622 such as, but not limited to, a level 1 cache, level 2 cache, level 3 cache or combination thereof. The aforementioned cache 622 may or may not be shared amongst a plurality of CPU cores 621. The cache 622 sharing comprises at least one of message passing and inter-core communication methods may be used for the at least one CPU Core 621 to communicate with the cache 622. The inter-core communication methods may comprise, but not limited to, bus, ring, two-dimensional mesh, and crossbar. The aforementioned CPU unit 620 may employ symmetric multiprocessing (SMP) design.

The plurality of the aforementioned CPU cores 621 may comprise soft microprocessor cores on a single field programmable gate array (FPGA), such as semiconductor intellectual property cores (IP Core). The plurality of CPU cores 621 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 621, for example, but not limited to Instruction-level parallelism (ILP) such as, but not limited to, superscalar pipelining, and Thread-level parallelism (TLP).

Consistent with the embodiments of the present disclosure, the aforementioned computing device 600 may employ a communication system that transfers data between components inside the aforementioned computing device 600, and/or the plurality of computing devices 600. The aforementioned communication system will be known to a person having ordinary skill in the art as a bus 630. The bus 630 may embody internal and/or external plurality of hardware and software components, for example, but not limited to a wire, optical fiber, communication protocols, and any physical arrangement that provides the same logical function as a parallel electrical bus. The bus 630 may comprise at least one of, but not limited to a parallel bus, wherein the parallel bus carry data words in parallel on multiple wires, and a serial bus, wherein the serial bus carry data in bit-serial form. The bus 630 may embody a plurality of topologies, for example, but not limited to, a multidrop/electrical parallel topology, a daisy chain topology, and a connected by switched hubs, such as USB bus. The bus 630 may comprise a plurality of embodiments, for example, but not limited to: Internal data bus (data bus) 631/Memory bus; Control bus 632; Address bus 633; System Management Bus (SMBus); Front-Side-Bus (FSB); External Bus Interface (EBI); Local bus; Expansion bus; Lightning bus; Controller Area Network (CAN bus); Camera Link; and/or ExpressCard.

The bus 630 may also comprise a plurality of embodiments, for example, but not limited to: Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.

The bus 630 may also comprise a plurality of embodiments, for example, but not limited to: Small Computer System Interface (SCSI)/Serial Attached SCSI (SAS); HyperTransport; InfiniBand; RapidIO; Mobile Industry Processor Interface (MIPI); Coherent Processor Interface (CAPI); Plug-n-play; 1-Wire.

The bus 630 may also comprise a plurality of embodiments, for example, but not limited to: Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (i.g. PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).

The bus 630 may further comprise a plurality of embodiments, for example, but not limited to: Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).

The bus 630 may comprise a Music Instrument Digital Interface (MIDI), or a Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 600 may employ hardware integrated circuits that store information for immediate use in the computing device 600, know to the person having ordinary skill in the art as primary storage or memory 640. The memory 640 operates at high speed, distinguishing it from the non-volatile storage sub-module 661, which may be referred to as secondary or tertiary storage, which provides slow-to-access information but offers higher capacities at lower cost. The contents contained in memory 640, may be transferred to secondary storage via techniques such as, but not limited to, virtual memory and swap. The memory 640 may be associated with addressable semiconductor memory, such as integrated circuits consisting of silicon-based transistors, used for example as primary storage but also other purposes in the computing device 600. The memory 640 may comprise a plurality of embodiments, such as, but not limited to volatile memory, non-volatile memory, and semi-volatile memory. It should be understood by a person having ordinary skill in the art that the ensuing are non-limiting examples of the aforementioned memory:

Volatile memory which requires power to maintain stored information, for example, but not limited to, Dynamic Random-Access Memory (DRAM) 641, Static Random-Access Memory (SRAM) 642, CPU Cache memory 625, Advanced Random-Access Memory (A-RAM), and other types of primary storage such as Random-Access Memory (RAM).

Non-volatile memory which can retain stored information even after power is removed, for example, but not limited to, Read-Only Memory (ROM) 643, Programmable ROM (PROM) 644, Erasable PROM (EPROM) 645, Electrically Erasable PROM (EEPROM) 646 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.

Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 600 may employ the communication system between an information processing system, such as the computing device 600, and the outside world, for example, but not limited to, human, environment, and another computing device 600. The aforementioned communication system will be known to a person having ordinary skill in the art as I/O 660. The I/O module 660 regulates a plurality of inputs and outputs with regard to the computing device 600, wherein the inputs are a plurality of signals and data received by the computing device 600, and the outputs are the plurality of signals and data sent from the computing device 600. The I/O module 660 interfaces a plurality of hardware, such as, but not limited to, non-volatile storage 661, communication devices 662, sensors 663, and peripherals 664. The plurality of hardware is used by the at least one of, but not limited to, human, environment, and another computing device 600 to communicate with the present computing device 600. The I/O module 660 may comprise a plurality of forms, for example, but not limited to channel I/O, port mapped I/O, asynchronous I/O, and Direct Memory Access (DMA).

Consistent with the embodiments of the present disclosure, the aforementioned computing device 600 may employ the non-volatile storage sub-module 661, which may be referred to by a person having ordinary skill in the art as one of secondary storage, external memory, tertiary storage, off-line storage, and auxiliary storage. The non-volatile storage sub-module 661 may not be accessed directly by the CPU 620 without using intermediate area in the memory 640. The non-volatile storage sub-module 661 does not lose data when power is removed and may be two orders of magnitude less costly than storage used in memory module, at the expense of speed and latency. The non-volatile storage sub-module 661 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (661) may comprise a plurality of embodiments, such as, but not limited to:

Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO); and

Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.

The non-volatile storage sub-module (661) may also comprise a plurality of embodiments, such as, but not limited to: Magnetic storage such as, but not limited to, Hard Disk Drive (HDD), tape drive, carousel memory, and Card Random-Access Memory (CRAM); Phase-change memory; Holographic data storage such as Holographic Versatile Disk (HVD); Molecular Memory; and/or Deoxyribonucleic Acid (DNA) digital data storage.

Consistent with the embodiments of the present disclosure, the aforementioned computing device 600 may employ the communication sub-module 662 as a subset of the I/O 660, which may be referred to by a person having ordinary skill in the art as at least one of, but not limited to, computer network, data network, and network. The network allows computing devices 600 to exchange data using connections, which may be known to a person having ordinary skill in the art as data links, between network nodes. The nodes comprise network computer devices 600 that originate, route, and terminate data. The nodes are identified by network addresses and can include a plurality of hosts consistent with the embodiments of a computing device 600. The aforementioned embodiments include, but not limited to personal computers, phones, servers, drones, and networking devices such as, but not limited to, hubs, switches, routers, modems, and firewalls.

Two nodes can be said are networked together, when one computing device 600 is able to exchange information with the other computing device 600, whether or not they have a direct connection with each other. The communication sub-module 662 supports a plurality of applications and services, such as, but not limited to World Wide Web (WWW), digital video and audio, shared use of application and storage computing devices 600, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 662 may comprise a plurality of size, topology, traffic control mechanism and organizational intent. The communication sub-module 662 may comprise a plurality of embodiments, such as, but not limited to: Wired communications, such as, but not limited to, coaxial cable, phone lines, twisted pair cables (ethernet), and InfiniBand; Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength); Parallel communications, such as, but not limited to, LPT ports; Serial communications, such as, but not limited to, RS-232 and USB; Fiber Optic communications, such as, but not limited to, Single-mode optical fiber (SMF) and Multi-mode optical fiber (MMF); and/or Power Line communications.

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 600 may employ the sensors sub-module 663 as a subset of the I/O 660. The sensors sub-module 663 comprises at least one of the devices, modules, and subsystems whose purpose is to detect events or changes in its environment and send the information to the computing device 600. Sensors are sensitive to the measured property, are not sensitive to any property not measured, but may be encountered in its application, and do not significantly influence the measured property. The sensors sub-module 663 may comprise a plurality of digital devices and analog devices, wherein if an analog device is used, an Analog to Digital (A-to-D) converter must be employed to interface the said device with the computing device 600. The sensors may be subject to a plurality of deviations that limit sensor accuracy. The sensors sub-module 663 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.

Acoustic, sound and vibration sensors, such as, but not limited to, microphone, lace sensor (guitar pickup), seismometer, sound locator, geophone, and hydrophone.

Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.

Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.

Flow and fluid velocity sensors, such as, but not limited to, air flow meter, anemometer, flow sensor, gas meter, mass flow sensor, and water meter.

Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.

Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.

Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.

Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.

Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.

Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.

Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.

Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 600 may employ the peripherals sub-module 662 as a subset of the I/O 660. The peripheral sub-module 664 comprises ancillary devices uses to put information into and get information out of the computing device 600. There are 3 categories of devices comprising the peripheral sub-module 664, which exist based on their relationship with the computing device 600, input devices, output devices, and input/output devices. Input devices send at least one of data and instructions to the computing device 600. Input devices can be categorized based on, but not limited to: Modality of input, such as, but not limited to, mechanical motion, audio, visual, and tactile; Whether the input is discrete, such as but not limited to, pressing a key, or continuous such as, but not limited to position of a mouse; The number of degrees of freedom involved, such as, but not limited to, two-dimensional mice vs three-dimensional mice used for Computer-Aided Design (CAD) applications; Output devices provide output from the computing device 600. Output devices convert electronically generated information into a form that can be presented to humans. Input/output devices perform that perform both input and output functions.

It should be understood by a person having ordinary skill in the art that the ensuing are non-limiting embodiments of the aforementioned peripheral sub-module 664: Input Devices; Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).

High degree of freedom devices, that require up to six degrees of freedom such as, but not limited to, camera gimbals, Cave Automatic Virtual Environment (CAVE), and virtual reality systems.

Video Input devices are used to digitize images or video from the outside world into the computing device 600. The information can be stored in a multitude of formats depending on the user's requirement. Examples of types of video input devices include, but not limited to, digital camera, digital camcorder, portable media player, web cam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.

Audio input devices are used to capture sound. In some cases, an audio output device can be used as an input device, in order to capture produced sound. Audio input devices allow a user to send audio signals to the computing device 600 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.

Data AcQuisition (DAQ) devices covert at least one of analog signals and physical parameters to digital values for processing by the computing device 600. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:

Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.

Audio and Video (AV) devices, such as, but not limited to, speakers, headphones, amplifiers and lights, which include lamps, strobes, DJ lighting, stage lighting, architectural lighting, special effect lighting, and lasers.

Other Devices Such as Digital to Analog Converter (DAC)

Input/Output Devices may further comprise, but not be limited to, touchscreens, networking device (e.g., devices disclosed in network 662 sub-module), data storage device (non-volatile storage 661), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### Aspects

The following disclose various Aspects of the present disclosure. The various Aspects are not to be construed as patent claims unless the language of the Aspect appears as a patent claim. The Aspects describe various non-limiting embodiments of the present disclosure.

Aspects Include:

Aspect 1: a method of coordinated delivery of a dining experience includes presenting a menu or multiple menus from different restaurants to a customer, receiving a request from the customer including at least one food item, and coordinating completed order pickup from one or more restaurants by a delivery provider such that a consistent and pleasing dining experience is provided to the customer.

Aspect 2: A System as illustrated in FIG. 1.

Aspect 3: A method as illustrated in FIG. 2.

Aspect 4: A method as illustrated in FIG. 3.

Aspect 5: A method as illustrated in FIG. 4.

Aspect 6: A method as illustrated in FIG. 5.

Aspect 7: A computing device arranged to perform the method according to FIG. 1.

Aspect 8: A computing device arranged to perform the method according to FIG. 2.

Aspect 9: A computing device arranged to perform the method according to FIG. 3.

Aspect 10: A computing device arranged to perform the method according to FIG. 4.

Aspect 11: A computing device arranged to perform the method according to FIG. 5.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior disclosure. Further, the dates of publication provided herein can be different from the actual publication dates, which can require independent confirmation.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A kitchen management platform configured to do the following:
receive a multi-restaurant request, the multi-restaurant request comprising a request of one or more food items from at least one customer,
wherein the one or more food items is associated with a plurality of restaurants;
identify a time latency to begin a new food item preparation for each of the plurality of restaurants;
compare a plurality of predetermined preparation times of the one or more food items;
schedule, based on the comparing, a plurality of times to begin preparation of the one or more food items;
transmit the plurality of times to begin preparation to the plurality of restaurants;
generate a plurality of proposed pickup times, based on the scheduling, of the one or more food items; and
transmit the plurality of proposed pickup times to a driver management module.

2. The kitchen management platform of claim 1, wherein the multi-restaurant request further comprises at least one of the following:
at least one delivery address;
payment information of the at least one customer;
contact information of the at least one customer;
a desired delivery time; and
desired service options.

3. The kitchen management platform of claim 2, further configured to transmit a completion indicator upon a completed pickup from a delivery provider of the one or more food items.

4. The kitchen management platform of claim 3, further configured to transmit payment from the at least one customer, to the plurality of restaurants based on the completion indicator.

5. A driver management platform configured to do the following:
receive a multi-restaurant request, the multi-restaurant request comprising a request of one or more food items from at least one customer,
wherein the one or more food items is associated with a plurality of restaurants;
analyze, via the multi-restaurant request, the following:
location data of the plurality of restaurants, and
a plurality of food parameters,
prioritize, based on the analysis, the following:
a plurality of pickup times of the one or more food items, and
a plurality of delivery times to the at least one customer;
request at least one delivery provider, the request comprising:
an availability to arrive at the plurality of pickup times and the plurality of delivery times, and
at least one prerequisite item relating to the multi-restaurant request; and
schedule, upon an acceptance of the at least one delivery provider, with the at least one delivery provider, the plurality of pickup times and the plurality of delivery times.

6. The driver management platform of claim 5, wherein the at least one prerequisite item comprises at least one of the following:
at least one thermal container;
at least one chafing apparatus;
at least one cooler; and
at least one storage apparatus.

7. The driver management platform of claim 5, wherein the plurality of food parameters comprises at least one of the following:
requested temperature of the one or more food items; and
requested timing of delivery of the one or more food items.

8. The driver management platform of claim 5, wherein prioritizing the plurality of pickup times and the plurality of delivery times are based one at least one of the following:
calculated cooldown times for hot food items;
calculated heat up times for cold food items;
distance between at least one pickup location and at least one delivery location;
traffic conditions between the at least one pickup location and the at least one delivery location; and
weather conditions between the at least one pickup location and the at least one delivery location.

9. The driver management platform of claim 5, wherein the at least one delivery provider comprises a dispatch time availability.

10. The driver management platform of claim 5, wherein the multi-restaurant request comprises a payment of the one or more food items.

11. The driver management platform of claim 5, further configured to receive inventory availability of the plurality of restaurants.

12. The driver management platform of claim 11, further configured to update the multi-restaurant request based on the inventory availability of the plurality of restaurants.

13. A delivery platform integration system configured to do the following:
receive a multi-restaurant request, the multi-restaurant request comprising a request of one or more food items from at least one customer,
wherein the one or more food items is associated with a plurality of restaurants;
analyze, via the multi-restaurant request, the following:
location data of the plurality of restaurants, and
a plurality of food parameters,
prioritize, based on the analysis, the following:
a plurality of pickup times of the one or more food items, and
a plurality of delivery times of the one or more food items to the at least one customer;
schedule the plurality of pickup times and the plurality of delivery times;
transmit, to a third-party delivery platform, the scheduled plurality of pickup times and the scheduled plurality of delivery times.

14. The delivery platform integration system of claim 13, wherein the multi-restaurant request may further comprise at least one of the following:
at least one delivery address;
payment information of the at least one customer;
contact information of the at least one customer;
a desired delivery time; and
desired service options.

15. The delivery platform integration system of claim 14, further configured to receive a delivery completion indicator upon a completed delivery of the one or more food items to the at least one customer.

16. The delivery platform integration system of claim 15, further configured to transmit payment from the at least one customer, to the third-party delivery platform based on the delivery completion indicator.

17. The delivery platform integration system of claim 13, wherein the plurality of food parameters comprises at least one of the following:
requested temperature of the one or more food items; and
requested timing of delivery of the one or more food items.

18. The delivery platform integration system of claim 13, wherein prioritizing the plurality of pickup times and the plurality of delivery times are based one at least one of the following:
calculated cooldown times for hot food items;
calculated heat up times for cold food items;
distance between at least one pickup location and at least one delivery location;
traffic conditions between the at least one pickup location and the at least one delivery location; and
weather conditions between the at least one pickup location and the at least one delivery location.

19. The delivery platform integration system of claim 13, wherein the multi-restaurant request comprises a payment of the one or more food items.

20. The delivery platform integration system of claim 13, further configured to receive inventory availability of the plurality of restaurants.
